(19) United States
(12) Patent Application Publication
(10) Pub. No.: US 2026/0267656 A1
(43) Pub. Date: Sep. 10, 2026

(54) HIERARCHICAL CLUSTER USING CONTAINER ORCHESTRATION

(71) Applicant: INTERNATIONAL BUSINESS MACHINES CORPORATION, ARMONK, NY (US)

(72) Inventors: Paritosh RANJAN, Kolkata (IN); Bhubaneswar PADHAN, KOLKATA (IN); Prodip ROY, Kolkata (IN); SWARUP KUMAR SIKDER, Kolkata (IN)

(21) Appl. No.: 19/022,188

(22) Filed: Jan. 15, 2025

(51) Int. Cl. G06F 9/38; G06F 9/455

(52) U.S. Cl. CPC G06F 9/3891; G06F 9/455; G06F 2009/4557

(57) ABSTRACT

Described are techniques for a hierarchical cluster using container orchestration. The techniques include creating a hierarchical cluster of hierarchically organized connected clusters, where a respective cluster of the hierarchical cluster comprises at least one pod configured to perform the operations that include: receiving a command at the respective cluster of the hierarchical cluster for execution by at least a portion of the hierarchical cluster; executing the command at the respective cluster of the hierarchical cluster; determining a scope of the command by evaluating the command to identify one or more clusters of the hierarchical cluster that are connected to the respective cluster and are included in the scope of the command; and distributing the command to the one or more clusters of the hierarchical cluster that are connected to the respective cluster and are included in the scope of the command.

### BACKGROUND

The present disclosure relates to containerization, and, more specifically, to container orchestration for managing containerized applications.

Application containers are used for building, packaging, and deploying software. In the simplest terms, an application container includes both application code and the dependencies that the application code needs to execute properly. Multiple application containers (also called containerized workloads or containerized applications) can execute on the same machine and share an operating system (OS) kernel with other application containers, each running as isolated processes in a user space. Container orchestration is the automation of operational tasks needed to run containerized workloads or applications and services. These operational tasks include management of a container's lifecycle, such as application container provisioning, deployment, scaling (up and down), networking, and load balancing.

### SUMMARY

Aspects of the present disclosure are directed toward a computer-implemented method that comprises creating a hierarchical cluster of hierarchically organized connected clusters. A respective cluster of the hierarchical cluster includes at least one pod that is configured to perform operations that include: receiving a command at the respective cluster of the hierarchical cluster for execution by at least a portion of the hierarchical cluster; executing the command at the respective cluster of the hierarchical cluster; determining a scope of the command by evaluating the command to identify one or more clusters of the hierarchical cluster that are connected to the respective cluster and are included in the scope of the command; and distributing the command to the one or more clusters of the hierarchical cluster that are connected to the respective cluster and are included in the scope of the command.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example compute environment for implementing a hierarchical cluster, in accordance with some embodiments of the present disclosure.

FIG. 2 is a block diagram that illustrates example components for performing operations associated with a hierarchical cluster, in accordance with some embodiments of the present disclosure.

FIG. 3 is a diagram that illustrates an example hierarchical cluster, in accordance with some embodiments of the present disclosure.

FIG. 4 is a diagram that illustrates execution of a command on an example hierarchical cluster, in accordance with some embodiments of the present disclosure.

FIG. 5 is a flow diagram illustrating an example method for creating a hierarchical cluster and performing commands by the hierarchical cluster, in accordance with some embodiments of the present disclosure.

FIG. 6 is a flow diagram that illustrates an example method for providing a status of a command to an issuer of the command, in accordance with some embodiments of the present disclosure.

FIG. 7 is a flow diagram illustrating an example method for forwarding status information for a command up the hierarchy of a hierarchical cluster, in accordance with some embodiments of the present disclosure.

FIG. 8 is a flow diagram that illustrates an example method for inserting a new cluster into a hierarchical cluster, in accordance with some embodiments of the present disclosure.

FIG. 9 is a flow diagram illustrating an example method for removing a cluster from a hierarchical cluster, in accordance with some embodiments of the present disclosure.

FIG. 10 is a flow diagram that illustrates an example method for removing a respective cluster from a hierarchical cluster, in accordance with some embodiments of the present disclosure.

FIG. 11 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward container orchestration for implementing a hierarchical cluster. While not limited to such applications, embodiments of the present disclosure may be better understood in light of the following context.

The implementation of cloud architectures has resulted in significant improvements to the efficiency of computer operations. By running many different applications in many different contexts, a cloud architecture can help maximize the utilization of computing resource capabilities. One common component of modern cloud architectures is the container. A container is a software package that contains the software components needed for executing an application. This includes the executable program as well as system tools, libraries, and settings. Containers provide developers with the ability to create predictable environments that are isolated from other applications. Containers can also include software dependencies needed by the executable program, such as specific versions of programming language runtimes and other software libraries.

A container-orchestration system can be used to automate deployment, scaling, and management of applications using containers. Kubernetes® is one example of an open source container-orchestration system. The Kubernetes® container-orchestration system defines an architecture of clusters and pods for running applications using containers. A cluster is a set of node machines (also referred to as “worker nodes”) that execute pods. A pod is the smallest deployable unit of computing (an object that has a state, associated operations, and can be accessed by an identifier) defined by the container-orchestration system, and the pod comprises a group of one or more tightly coupled containers that operate together. Although the present disclosure uses the term “pod” to refer to a grouping of one or more containers, it will be understood that the aspects of the present disclosure are not limited to the Kubernetes® container-orchestration system. Namely, as will be appreciated by persons of ordinary skill, the aspects of the present disclosure can be used with any appropriate container-orchestration system.

Currently, container orchestration systems limit the number of worker nodes that can be included in a cluster (e.g., Kubernetes® v1.31 supports clusters with up to 5,000 nodes). By limiting a cluster to a set number of worker nodes, a container orchestration system limits scaling of a container-implemented application, which can result in degraded performance of the application during times that the compute requirements of the application exceed the cluster limitation imposed by the container orchestration system.

In order to overcome the cluster limitations imposed by container orchestration systems, aspects of the present disclosure create a hierarchical cluster that is managed as a single entity to provide cluster scalability capacity beyond that of the cluster limitations imposed by current container orchestration systems. The hierarchical cluster comprises a set of clusters organized into a hierarchy of one or more cluster levels. The hierarchical cluster can include a root cluster that forms the top of the hierarchical cluster and descendant clusters that descend from the root cluster to form one or more levels of the hierarchical cluster. Each cluster in the hierarchical cluster includes one or more components configured to perform hierarchical cluster operations. These operations can include adding and removing clusters to/from the hierarchical cluster; receiving commands from, and distributing the commands to, other clusters in the hierarchical cluster; collecting command results from other clusters in the hierarchical cluster and providing a command status to an issuer of a command; as well as other hierarchical cluster operations.

This hierarchical cluster allows the connected clusters to interface with each other to scale compute capacity beyond that of what is currently allowed by container orchestration systems, which is an improvement in the technical field of container orchestration generally, and more particularly, in the technical field of compute capacity scaling. These advantages, as well as other advantages of the present disclosure are described below.

According to an aspect of the present disclosure, there is provided a computer-implemented method comprising creating a hierarchical cluster of hierarchically organized connected clusters. Each respective cluster of the hierarchical cluster comprises a group of worker nodes that host pods of one or more containers. One or more of the pods are configured to perform operations that include: receiving a command at the respective cluster of the hierarchical cluster, where the command is for execution by at least a portion of the hierarchical cluster; executing the command at the respective cluster of the hierarchical cluster; determining a scope of the command, where the command is evaluated to identify one or more clusters of the hierarchical cluster that are connected to the respective cluster and are included in the scope of the command; and distributing the command to the one or more clusters of the hierarchical cluster that are connected to the respective cluster and are included in the scope of the command. Advantageously, the computer-implemented method has the technical effects of creating a hierarchical cluster that expands compute capacity beyond that of a single cluster and executing commands on the hierarchical cluster as a whole, as well as executing commands on selected portions of the hierarchical cluster.

According to an aspect of the computer-implemented method, creating the hierarchical cluster further comprises: creating a root cluster of the hierarchical cluster to include the one or more pods configured to perform the operations that include the receiving, executing, and distributing of the commands; and creating one or more descendant clusters that descend from the root cluster, the one or more descendant clusters including the one or more pods configured to perform the operations that include the receiving, executing, and distributing of the commands. Advantageously, this aspect of the computer-implemented method has the technical effect of creating a hierarchy of connected clusters to enable execution of commands on the hierarchical cluster as a whole and/or on selected portions of the hierarchical cluster.

According to an aspect of the computer-implemented method, creating the hierarchical cluster further comprises: generating hierarchical cluster metadata to indicate a hierarchy of the connected clusters; and storing the hierarchical cluster metadata on each cluster of the hierarchical cluster to enable each cluster of the hierarchical cluster to identify the connected clusters. Advantageously, this aspect of the computer-implemented method has the technical effect of connecting the clusters of the hierarchical cluster via the hierarchical cluster metadata, which allows the connected clusters to receive and distribute commands associated with the hierarchical cluster.

According to an aspect of the computer-implemented method, the one or more pods are further configured to perform operations that include: providing information related to executing the command at the respective cluster to an entity from which the respective cluster received the command; receiving, from the one or more clusters connected to the respective cluster, additional information related to execution of the command at clusters directly and indirectly connected to the respective cluster that are within the scope of the command; and providing the additional information to the entity from which the respective cluster received the command. Advantageously, this aspect of the computer-implemented method has the technical effect of distributing the results of a command executed by the hierarchical cluster through the hierarchy of clusters to an issuer of the command.

According to an aspect of the computer-implemented method, the one or more pods are further configured to perform operations that include: maintaining hierarchical cluster metadata for the hierarchical cluster at the respective cluster, including updating the hierarchical cluster metadata to reflect changes to the hierarchical cluster initiated at the respective cluster; and providing updates to the hierarchical cluster metadata to the one or more clusters of the hierarchical cluster that are connected to the respective cluster to enable the one or more clusters to update the hierarchical cluster metadata maintained at the one or more clusters. Advantageously, this aspect of the computer-implemented method has the technical effect of maintaining current information for connected clusters on each cluster of the hierarchical cluster, which results in a reliable data structure for a compute environment.

According to an aspect of the computer-implemented method, the one or more pods are further configured to perform operations that include: inserting a new cluster into the hierarchical cluster, where hierarchical cluster metadata for the hierarchical cluster is updated to connect the new cluster to the respective cluster; and removing a connected cluster from the hierarchical cluster, where the connected cluster is connected to the respective cluster and the hierarchical cluster is updated to remove the connected cluster from the respective cluster. Advantageously, this aspect of the computer-implemented method has the technical effect of scaling the hierarchical cluster to increase or decrease the number of clusters in the hierarchical cluster according to a demand for computing resources provided by the hierarchical cluster.

According to an aspect of the computer-implemented method, the one or more pods are further configured to perform operations that include removing the respective cluster from the hierarchical cluster in response to a command that instructs the respective cluster to remove itself form the hierarchical cluster. Advantageously, this aspect of the computer-implemented method has the technical effect of decreasing the amount of computing resources provided by the hierarchical cluster, thereby freeing up the computing resources for use by other purposes, as will be appreciated by persons of ordinary skill.

According to an aspect of the computer-implemented method, determining the scope of the command further comprises evaluating the command to determine a subtree of clusters of the hierarchical cluster that is to execute the command. Advantageously, this aspect of the computer-implemented method has the technical effect of selecting a subtree of clusters of the hierarchical cluster to execute a command, which allows for partition management of the clusters in the hierarchical cluster.

According to an aspect of the computer-implemented method, determining the scope of the command further comprises evaluating the command to determine a percentage of clusters of the hierarchical cluster that are to execute the command. Advantageously, this aspect of the computer-implemented method has the technical effect of selecting a portion of clusters of the hierarchical cluster to execute a command, which allows for partition management of the clusters in the hierarchical cluster using a percentage parameter.

Additional aspects of the present disclosure are directed to systems configured to perform any of the functionality of any of the aspects of the aforementioned computer-implemented method, thereby realizing the associated advantages, improvements, and/or technical effects, previously described. Also, additional aspects of the present disclosure are directed to computer program products comprising one or more computer-readable storage media, and program instructions collectively stored on the one or more computer-readable storage media, the program instructions configured to cause one or more processors to perform any of the functionality of any of the aspects of the aforementioned system, thereby realizing the associated advantages, improvements, and/or technical effects, previously described.

Aspects of the present disclosure can be relevant to multiple technical use cases. As one example, the computer-implemented method described above can be used to create a hierarchical cluster of Kubernetes® clusters. The hierarchy of the clusters can be modified by adding and removing clusters to/from the hierarchical cluster. Actions defined by the Kubernetes® container orchestration system can be performed by the hierarchical cluster as a whole or a portion of the hierarchical cluster. Illustratively, an action can be performed by a parent cluster and its child cluster(s), or an action can be performed by an ancestor cluster(s) of a parent cluster, or an action can be performed by all clusters of a defined subtree of the hierarchical cluster, or a specified percentage of clusters of the hierarchical cluster, or a subtree of the hierarchical cluster.

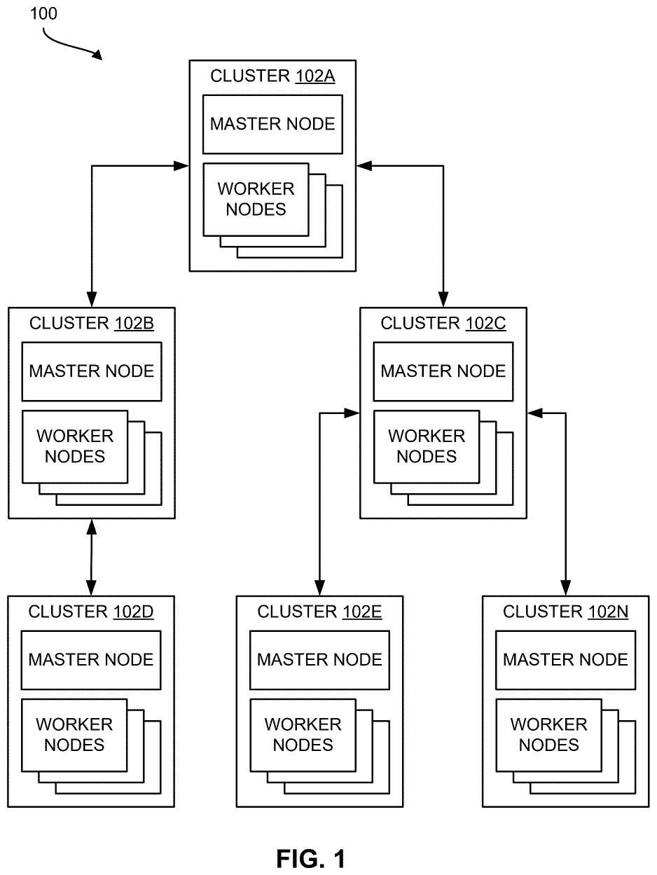

Referring now to the figures, FIG. 1 illustrates a block diagram of an example compute environment 100 that implements a hierarchical cluster, in accordance with some embodiments of the present disclosure. The example compute environment 100 includes components of a container-orchestration platform. The container-orchestration platform is designed to manage and automate the configuration, deployment, and operation of containerized applications in the compute environment 100. In some embodiments, the container-orchestration platform can be implemented using the Kubernetes® container-orchestration platform, although other container-orchestration platforms are within the scope of the present disclosure.

Components of the container-orchestration platform include a set of clusters 102A-N (collectively 102, where N can refer to any positive integer representing any number of clusters), where each cluster 102 comprises a master node and one or more worker nodes. The master node and the worker nodes can comprise physical or virtual machines. The master node operates as a control plane for a cluster 102, and includes components for managing cluster operations, including: a scheduler for scheduling worker node resources to pods; an application programming interface (API) server that exposes a Hypertext Transfer Protocol (HTTP) API to enable users, external services, and other clusters to communicate with the cluster; a controller manager to monitor the state of the cluster 102 and makes changes to maintain applications running on the cluster 102; a datastore (e.g., a distributed, open-source key-value store) for the cluster 102 to store and manage critical information, such as configuration data, state data, and metadata for a hierarchical cluster; as well as other components as will be appreciated by persons of ordinary skill. The worker nodes provide a runtime environment for running and maintaining pods that implement applications and services. A pod is a deployable unit of computing comprising one or more containers that package an application with its dependencies, libraries, and code.

As illustrated in FIG. 1, the set of clusters 102 form a hierarchical cluster. The structure of the hierarchical cluster comprises a tree data structure. A root cluster 102A forms a top level of the hierarchical cluster, and descendant clusters 102B-N that descend from the root cluster 102A form one or more additional levels of the hierarchical cluster. The clusters 102 interface with one another according to the hierarchy of the hierarchical cluster. Hierarchical cluster metadata maintained on each cluster 102 enables the clusters 102 to identify connected clusters (e.g., parent, child, and sibling clusters) and interface with the connected clusters.

Each cluster 102 in the hierarchical cluster includes one or more components for performing operations of the hierarchical cluster. These operations include, but are not limited to, operations to: create the hierarchical cluster; scale the hierarchical cluster; receive commands and distribute the commands to one or more other clusters 102 in the hierarchical cluster; collect command results from the one or more other clusters 102 in the hierarchical cluster; provide a command status to an issuer of a command (e.g., a user that issued the command or a parent cluster 102 that distributed the command); and other operations related to the hierarchical cluster as will be appreciated by persons of ordinary skill.

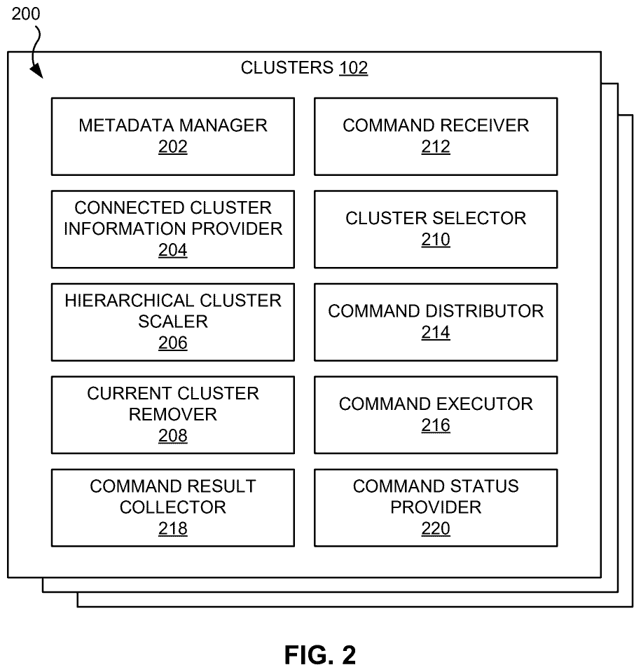

With continuing reference to FIG. 1, FIG. 2 illustrates example components 200 for performing operations of the hierarchical cluster, in accordance with some embodiments of the present disclosure. In the illustrated embodiment, each cluster 102 in the hierarchical cluster includes components 200 for hierarchical cluster setup, scaling, and executing workloads. In some embodiments, the components 200 can be implemented on a cluster 102 by one or more pods executed by a worker node. In some embodiments, the components 200 can be implemented on a cluster 102 as functionality provided by the cluster's master node.

In the following discussion and elsewhere herein, the terms “current cluster” and “respective cluster” refer to an individual cluster 102 in the hierarchical cluster and the components 200 of the individual cluster 102, and how the individual cluster 102 and its components 200 operate in relation to one another, and in relation to other clusters 102 of the hierarchical cluster. For example, when describing a particular component 200 below, a reference to “the current cluster” or “the respective cluster” is a reference to any individual cluster 102 that hosts the particular component 200.

The components 200 included on a cluster 102 of the hierarchical cluster include hierarchical cluster setup and scaling components. In the illustrated example, the hierarchical cluster setup and scaling components include a metadata manager 202, a connected cluster information provider 204, a hierarchical cluster scaler 206, and a current cluster remover 208. These components can be implemented using one or more pods deployed to each cluster 102 of the hierarchical cluster.

The metadata manager 202 maintains metadata information about the hierarchical cluster. The metadata information, hereinafter referred to as “hierarchical cluster metadata”, can be maintained on each cluster 102 that forms the hierarchical cluster. A structured file format can be used for the hierarchical cluster metadata. The structured file format can comprise a JSON (JavaScript Object Notation) file, YAML (Yet Another Markup Language) file, XML (Extensible Markup Language) file, or any other structured file format. Illustratively, the hierarchical cluster metadata can include, but is not limited to, a unique cluster identifier (e.g., name or sequence number) for the current cluster; cluster identifiers for clusters 102 connected to the current cluster and a relationship (parent, child, sibling) of the clusters 102 to the current cluster; and cluster authentication information (e.g., a Kubeconfig file) for the clusters 102, where the cluster authentication information can include a cluster's API server address, authentication credentials, cluster-specific settings, etc. In the illustrated example, the hierarchical cluster metadata maintained on a current cluster includes information for the current cluster, parent cluster, and any child clusters. Alternatively, in some embodiments, the hierarchical cluster metadata maintained on a cluster 102 can include information for each cluster 102 of the hierarchical cluster.

In some embodiments, hierarchical cluster metadata for a hierarchical cluster can be created prior to provisioning the hierarchical cluster. Thereafter, at the time of provisioning the hierarchical cluster, the hierarchical cluster metadata can be embedded in each of the individual clusters 102 that form the hierarchical cluster. In some embodiments, the hierarchy of the hierarchical cluster can be setup manually in each individual cluster 102 of the hierarchical cluster as part of deploying pods to a cluster 102, where a pod contains the hierarchical cluster metadata in the pod configuration.

In some embodiments, the hierarchical cluster metadata can be generated after provisioning of the hierarchical cluster by traversing the complete hierarchy of the hierarchical cluster and collecting hierarchy information from each cluster 102. Any known tree traversal technique can be used to traverse the hierarchical cluster. In traversing the clusters 102 of the hierarchical cluster, the metadata of each cluster 102 can be forwarded to the next cluster, and at the end of the traversal, hierarchical cluster metadata for the complete hierarchical cluster can be generated.

As part of managing hierarchical cluster metadata stored on a current cluster (i.e., a cluster 102 on which the metadata manager 202 is located), the metadata manager 202 updates the hierarchical cluster metadata in response to changes to the structure of the clusters 102 that form the hierarchical cluster (e.g., insertions and/or removals of clusters 102 to/from the hierarchical cluster). Information related to any changes to the hierarchical cluster can be provided to the metadata manager 202 by the other components located on the current cluster, and the metadata manager 202 can use the information to update the hierarchical cluster metadata stored on the current cluster.

The connected cluster information provider 204 provides information about connected clusters 102 (e.g., parent, child, sibling clusters) to the other components 200 located on a current cluster (i.e., the cluster 102 on which the connected cluster information provider 204 is located). Illustratively, the components 200 located on the current cluster can utilize information about the connected clusters 102 to perform various operations. These components 200 can request the information from the connected cluster information provider 204, and in response, the connected cluster information provider 204 can obtain the information from the metadata manager 202 and provide the information to the requesting component.

The hierarchical cluster scaler 206 performs operations associated with scaling the hierarchical cluster by inserting clusters 102 into the hierarchical cluster and removing clusters 102 from the hierarchical cluster. In the illustrated example, the hierarchical cluster scaler 206 inserts a new cluster into the hierarchical cluster by connecting a newly created cluster or an existing cluster to the current cluster (i.e., the cluster 102 on which the hierarchical cluster scaler 206 is located). In the case of a newly created cluster, the hierarchical cluster scaler 206 can be provided with cluster provisioning API details and credentials for creating new clusters.

The hierarchical cluster scaler 206 connects a new cluster to the current cluster by adding information for the new cluster to the hierarchical cluster metadata maintained on the current cluster. The information for the new cluster can include a unique cluster identifier; a relationship (child, sibling) of the new cluster to the current cluster; and cluster authentication information (e.g., a Kubeconfig file) for the new cluster. The hierarchical cluster scaler 206 provides the information to the metadata manager 202, which adds the information to the hierarchical cluster metadata stored on the current cluster.

The hierarchical cluster scaler 206 removes a cluster 102 from the hierarchical cluster by disconnecting an existing cluster (e.g., a child cluster) from the current cluster. The hierarchical cluster scaler 206 disconnects the existing cluster by removing the connected cluster's information from the hierarchical cluster metadata stored on the current cluster. Illustratively, the hierarchical cluster scaler 206 removes the information for the existing cluster from the hierarchical cluster metadata by sending a removal request and a cluster identifier for the existing cluster to the metadata manager 202, which in response to receiving the request, removes the information linked to the cluster identifier from the hierarchical cluster metadata stored on the current cluster. This disconnects the existing cluster from the hierarchical cluster, but does not delete the cluster resources. As such, if commanded, the hierarchical cluster scaler 206 can also delete the existing cluster (delete the computing resources of the existing cluster) using deletion API details and credentials provided to the hierarchical cluster scaler 206.

In the illustrated example, the current cluster includes the means for removing itself from the hierarchical cluster. Prior to removal of the current cluster, any child clusters of the current cluster are first removed from the hierarchical cluster. Thereafter, the current cluster remover 208 performs operations associated with removing the current cluster from the hierarchical cluster. The current cluster remover 208 accomplishes this by sending a message to its parent cluster requesting that the parent cluster remove the current cluster from the hierarchical cluster metadata maintained by the parent cluster. The request includes a cluster identifier for the current cluster and instructions for the parent cluster to remove the information for the current cluster from the hierarchical cluster metadata maintained on the parent cluster. Removing the current cluster from the hierarchical cluster metadata of the parent cluster disconnects the current cluster from the hierarchical cluster. In the case that the current cluster is not deleted (e.g., the current cluster is preserved for later reallocation), the current cluster remover 208 removes information for parent cluster and any child clusters from the current cluster's hierarchical cluster metadata. In the case that the current cluster is commanded to delete itself, the current cluster remover 208 deletes the computing resources of the current cluster by calling deletion APIs provided by the container-orchestration platform.

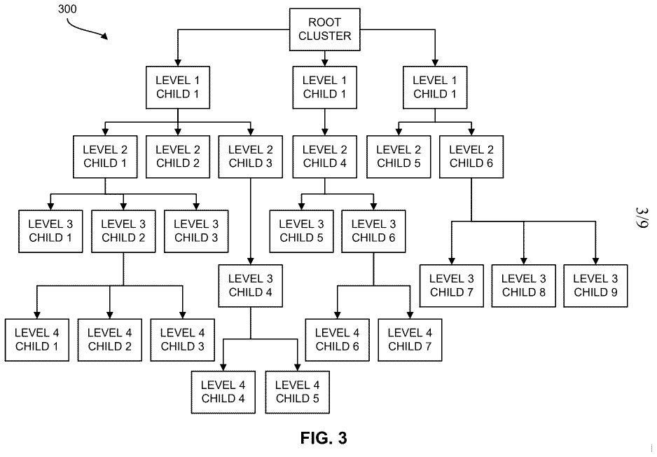

With continuing reference to FIG. 2, FIG. 3 illustrates an example hierarchical cluster 300, in accordance with some embodiments of the present disclosure. As shown, the hierarchical cluster 300 includes a root cluster and a hierarchy of descendant clusters. Setup of the hierarchical cluster 300 can comprise deploying the root cluster to include the components 200 illustrated in FIG. 2 and creating hierarchical cluster metadata for the root cluster that is stored on the root cluster. The root cluster's hierarchical cluster metadata includes a cluster identifier (e.g., name or sequence number) that identifies the root cluster as the topmost cluster of the hierarchical cluster 300, as well as information for child clusters connected to the root cluster and cluster authentication information (e.g., a Kubeconfig file) for the root cluster.

Descendant clusters are also deployed to the hierarchical cluster 300 to include the components 200 illustrated in FIG. 2. Hierarchical metadata is generated for each individual descendant cluster and stored on the individual descendant cluster. The hierarchical metadata for an individual descendant cluster includes a cluster identifier (e.g., name or sequence number) that uniquely identifies the descendant cluster in the hierarchy of the hierarchical cluster 300. As a non-limiting example, a cluster identifier for a descendant cluster can signify a level of the cluster in the hierarchy and a relation to an immediately connected cluster (e.g., parent cluster). The hierarchical metadata also includes authentication information (e.g., a Kubeconfig file) for the descendant cluster and for connected cluster(s). The descendant clusters are inserted into the hierarchical cluster 300 by indicating in the hierarchical metadata the cluster's relationship to a connected cluster (e.g., parent, child, sibling). Thus, the structure of the hierarchical cluster 300 comprises a tree data structure of connected clusters.

Referring again to FIG. 1 and FIG. 2, the components 200 included on each cluster 102 of the hierarchical cluster also include components that perform operations associated with managing the hierarchical cluster. These components include, but are not limited to, a command receiver 212, a cluster selector 210, a command distributor 214, a command executor 216, a command result collector 218, and a command status provider 220.

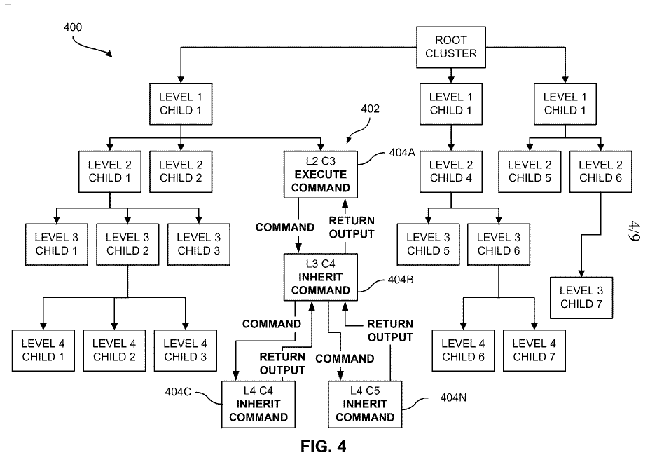

The command receiver 212 receives commands to be executed by at least a portion of the hierarchical cluster. The command receiver 212 acts as an interface to the hierarchical cluster via the current cluster to receive the commands. Because each cluster 102 of the hierarchical cluster includes the command receiver 212, each of the clusters 102 provides an interface to the hierarchical cluster, which allows a user to send a command to a target cluster in the hierarchical cluster to be executed by a target portion of the hierarchical cluster. In the case that a user wants a command to be executed by the hierarchical cluster as a whole (i.e., executed by all clusters 102 of the hierarchical cluster), the command can be sent to the command receiver 212 located on the root cluster 102A, which as described in detail later, distributes the command down the hierarchy of clusters, such that each descendant cluster 102B-N receives the command. Alternatively, the user can limit the command to a selected portion of the hierarchical cluster. For example, with reference to FIG. 2 and FIG. 4, the user can limit the command to a selected portion 402 (e.g., subtree) of the hierarchical cluster 400 by sending the command to the command receiver 212 of a target cluster 404A, and as will be described in more detail below, the command can then be distributed to the clusters 404B-N that descend from the target cluster 404A.

Returning to FIGS. 1 and 2, in some embodiments, commands can be sent to the command receiver 212 of a target cluster using a cloud platform command line interface (CLI), a container orchestration system CLI, or using an HTTP API for the target cluster. Examples of the commands include, but are not limited to: a deploy command that deploys a cluster(s) 102 to the hierarchical cluster; a get info command that obtains information for a cluster(s) 102, worker node(s) and/or pod(s) of the hierarchical cluster; a create namespace command that creates a namespace in the hierarchical cluster; a scale command that scales the hierarchical cluster; a restart command that restarts one or more clusters 102 included in the hierarchical cluster; as well as other commands as will be appreciated by persons of ordinary skill.

A command can include parameters that specify an action to be performed and identifies a cluster(s) 102 that is to perform the action. Illustratively, in the context of a cloud platform CLI for use with the Kubernetes® container orchestration system, a format of commands to add or remove a child, parent, or sibling cluster can comprise:
cloud kubernetes cluster-c <clusterid>child add-c <child-cluster-id>
cloud kubernetes cluster-c <clusterid>child remove-c <child-cluster-id>
cloud kubernetes cluster-c <clusterid>parent add-c <parent-cluster-id>
cloud kubernetes cluster-c <clusterid>parent remove-c <parent-cluster-id>
cloud kubernetes cluster-c <clusterid>sibling add-c <sibling-cluster-id>
cloud kubernetes cluster-c <clusterid>sibling remove-c <sibling-cluster-id>.
   In the context of a container orchestration system CLI, a format of commands to add or remove a child, parent, or sibling cluster can comprise:
kubectl child add-c <child-cluster-id>
kubectl child remove-c <child-cluster-id>
kubectl parent add-c <parent-cluster-id>
kubectl parent remove-c <parent-cluster-id>
kubectl sibling add-c <sibling-cluster-id>
kubectl sibling remove-c <sibling-cluster-id>
   And in the context of an HTTP API for use with the Kubernetes® container orchestration system, a format of commands to add or remove a child, parent, or sibling cluster can comprise:
/kubernetes/api/hierarchy/child/add? clusterid=<clusterid>&child-child-cluster-id=<child-cluster-id>
/kubernetes/api/hierarchy/child/remove? clusterid=<clusterid>&child-child-cluster-id=<child-cluster-id>
/kubernetes/api/hierarchy/parent/add? clusterid=<clusterid>&child-child-cluster-id=<parent-cluster-id>
/kubernetes/api/hierarchy/parent/remove? clusterid=<clusterid>&child-child-cluster-id=<parent-cluster-id>
/kubernetes/api/hierarchy/sibling/add? clusterid=<clusterid>&child-child-cluster-id=<sibling-cluster-id>
/kubernetes/api/hierarchy/sibling/remove? clusterid=<clusterid>&child-child-cluster-id=<sibling-cluster-id>

Also, a command can specify that the command is to be executed by the complete hierarchical cluster, a portion of the hierarchical cluster (e.g., a subtree of clusters 102 or a percentage of clusters 102), or solely by the current cluster (the cluster 102 that received the command). Illustratively, in the context of a cloud platform CLI for use with the Kubernetes® container orchestration system, a format of a command (e.g., get pods, deploy cluster, scale hierarchical cluster, etc.) that is to be executed by a tree/subtree under a cluster 102 of the hierarchical cluster can comprise:
cloud kubernetes cluster execute-command <kubernetes command>tree-root <cluster-id>-height-height of tree-direction <up/down>

In the illustrated example, in response to receiving a command at the current cluster, the command receiver 212 forwards the command to the cluster selector 210. The cluster selector 210 evaluates the parameters of the command to determine whether the command is to be executed by the complete hierarchical cluster, a portion of the hierarchical cluster (e.g., a subtree of the hierarchical cluster or a percentage of the hierarchical cluster), or just the current cluster.

In the case that the command is limited to the current cluster, the cluster selector 210 sends the command to the command executor 216 located on the current cluster. In response, the command executor 216 initiates execution of an operation in accordance with the command on the current cluster. As part of executing the operation on the current cluster, other components 200 may be called. As one example, where the command is directed to a scaling operation, the command executor 216 calls the hierarchical cluster scaler 206 to perform a scaling operation (e.g., insert or remove one or more clusters 102) in accordance with the parameters of the command. As another example, where a command is directed to removing the current cluster, the command executor 216 calls the current cluster remover 208 to perform removal operation that removes the current cluster from the hierarchical cluster.

In the case that the command is to be executed by either of, the entire hierarchical cluster, or a portion of the hierarchical cluster (which includes the current cluster), the cluster selector 210, for example, provides the command to the command executor 216 on the current cluster, which initiates execution of the command on the current cluster. In addition, the cluster selector 210 identifies one or more clusters 102 (e.g., child clusters) connected to the current cluster that are to receive the command. The cluster selector 210 identifies the connected cluster(s) by requesting information for clusters 102 that are connected to the current cluster from the connected cluster information provider 204. In response to the request, the connected cluster information provider 204 obtains the information from the metadata manager 202, which queries the hierarchical cluster metadata stored on the current cluster for the information. After obtaining the information for the connected cluster(s), the cluster selector 210 sends the command to the command distributor 214, which then distributes the command to the connected cluster(s) identified by the cluster selector 210. A connected cluster that receives the command (via the command receiver 212 located on the connected cluster) executes the command (via the command executor 216 located on the connected cluster), identifies additional clusters that are to receive the command (via the cluster selector 210 located on the connected cluster), and distributes the command (via the command distributor 214 located on the connected cluster) to its connected cluster(s). This process is continued until the command is distributed to each cluster 102 that has been identified for execution of the command (e.g., every cluster 102 of the hierarchical cluster, or each cluster 102 in a subtree of the hierarchical cluster).

In the case that the command is distributed to a percentage of the hierarchical cluster, the cluster selector 210 located on the connected cluster calculates a total number of clusters 102 that descend from the current cluster (e.g., using a tree traversal technique), and the cluster selector 210 determines the percentage of clusters 102 (N number of clusters 102) based on the total number of clusters 102. The cluster selector 210 then obtains cluster identifiers for the N number of clusters 102. Illustratively, the N number of clusters 102 can be from: the top of the subtree; the bottom of the subtree; or randomly selected. The command distributor 214 located on the connected cluster then distributes the command to its connected cluster(s) included in the N number of clusters 102, and this process continues until the command is distributed to each cluster included in the N number of clusters 102.

Each cluster 102 that receives the command provides return output to the issuer of the command. In the context of the root cluster 102A of the hierarchical cluster, the issuer of the command is a user (e.g., an individual, a computer, or an application). In the context of a child cluster 102B-N, the issuer of the command is a parent cluster. The command status provider 220 determines the status of the command executed at the current cluster and returns the status of the command as return output to the to the issuer of the command. The command result collector 218 receives and collects the return output of the command from connected cluster(s) and provides the return output to the issuer of the command. As such, the return output of the command is forwarded up the hierarchy of the hierarchical cluster (e.g., from child cluster to parent cluster) until it reaches the cluster 102 that first received the command (which can be the root cluster 102A of the hierarchical cluster, or a cluster 102B-N of a subtree of the hierarchical cluster selected to perform the command).

As an illustration of some of the operations performed by the components 200 described above, FIG. 4 shows the execution of a command by a portion (subtree 402) of a hierarchical cluster 400, in accordance with some embodiments of the present disclosure. As described above, a command can be targeted to a portion of a hierarchical cluster 400. The portion of the hierarchical cluster 400 can comprise a subtree 402 consisting of a target cluster 404A that forms a topmost node of the subtree 402, and descendant clusters 404B-N (collectively 404, where N can refer to any positive integer representing any number of descendant clusters) of the target cluster 404. The clusters 404 can include the components 200 described above in association with FIG. 2.

Execution of a command by the subtree 402 of the hierarchical cluster 400 can comprise sending, by a user, the command to the target cluster 404. The command can specify the target cluster 404A (e.g., via a unique identifier for the target cluster 404A) and one or more levels of the hierarchical cluster 400 to execute the command (e.g., via level indicators or a cluster percentage). In response to receiving the command, the target cluster 404A evaluates the parameters of the command to determine an operation specified by the command to perform, and determines whether to forward the command to a descendant cluster 404B (e.g., child cluster) connected to the target cluster 404A. In determining that the command should be forwarded to descendant cluster 404B, the target cluster 404A sends the command to descendant cluster 404B.

Descendant cluster 404B, in response to receiving the command, also evaluates the parameters of the command to determine the operation to be performed, and determines whether to forward the command to descendant clusters 404C and 404N. The descendant clusters 404C and 404N also evaluate the command to determine the operation to be performed. Also, evaluation of the command may indicate that descendant clusters 404C and 404N form the bottom of the subtree 402, and as such, descendant clusters 404C and 404N do not forward the command to any other clusters in the hierarchical cluster 400.

As part of performing the operation specified by the command, the descendant clusters 404B-N provide return output to the target cluster 404A. For example, descendant clusters 404C and 404N provide return output to descendant cluster 404B. Descendant cluster 404B collects the return output received from descendant clusters 404C and 404N and provides their return output along with its own return output to the target cluster 404A. Target cluster 404A receives the return output from descendent cluster 404B, and sends the return output along with its own return output to the user that issued the command. The return output can include information (results) for the command. For example, where the command is for scaling the subtree 402, the return output can include status information for the scaling procedure. In some embodiments, the clusters 404 can continuously or periodically provide the return output until the command completes or is cancelled.

In the illustrative examples above, the same reference numeral may be used in more than one figure. This reuse of a reference numeral in different figures represents the same element in the different figures. All or a portion of the hierarchical clusters and the components described in association with the figures can be implemented by all or a subset of the computing environment 1100 illustrated in FIG. 11. The components used to implement the hierarchical clusters can be implemented in software, hardware, firmware or a combination thereof. When software is used, the operations performed by the components can be implemented in program instructions configured to run on hardware, such as a processor. In some embodiments, the program instructions can be implemented in modules. Generally, modules (also referred to as program modules) include routines, programs, and/or data structures that perform particular tasks and/or implement particular abstract data types. In some embodiments, the modules can be implemented as computing services. For example, a module can be considered a service with one or more processes executing on a server or other computer hardware. Such services can provide a service application that receives requests and provides output to other services or consumer devices. An API can be provided for each module to enable a first module to send requests to and receive output from a second module. Such APIs can also allow third parties to interface with the module and make requests and receive output from the modules. When firmware is used, the operations performed by the components can be implemented in program instructions and data and stored in persistent memory to run on a processor unit. When hardware is employed, the hardware can include circuits that operate to perform the operations of the components described above.

One or more networks (not shown) can be provided to enable communication between the clusters of the hierarchical clusters described above, and as well as between the components located on the clusters. The network can include any useful computing network, including an intranet, the Internet, a local area network, a wide area network, a wireless data network, or any other such network or combination thereof. Components utilized for the network can depend at least in part upon the type of network and/or environment selected. Communication over the network can be enabled by wired or wireless connections and combinations thereof.

The term “datastore” and other information storage components relevant to operation and functionality of a component of a hierarchical cluster are utilized to refer to memory components. Memory components described herein can be either volatile memory or nonvolatile memory or can include both volatile and nonvolatile memory. While the illustrated figures show examples of a computational environment that can implement the techniques above, many other similar or different environments are possible. The example environments discussed and illustrated above are merely representative and not limiting.

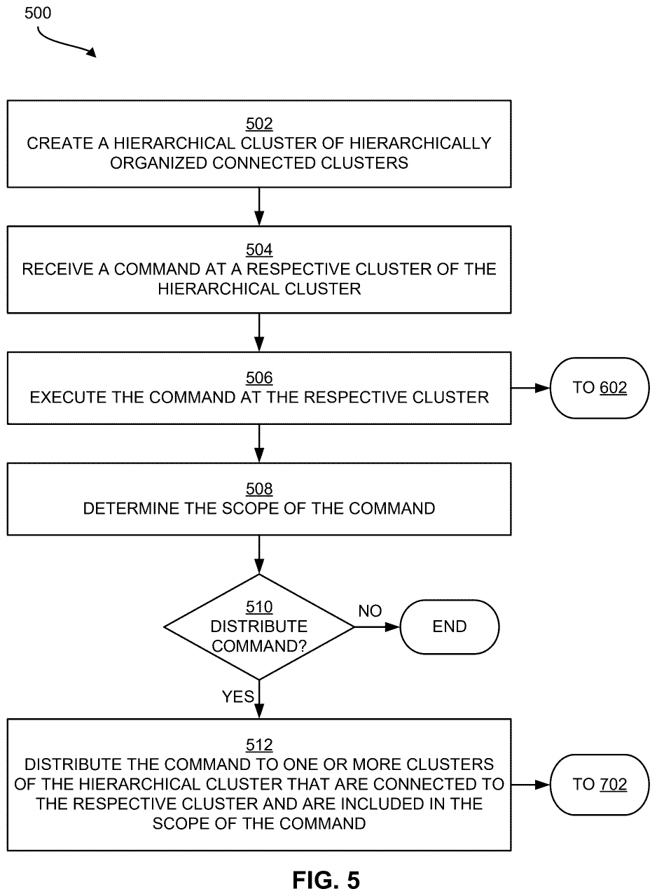

FIG. 5 is a flow diagram illustrating an example method 500 for creating a hierarchical cluster and performing commands by the hierarchical cluster, in accordance with some embodiments of the present disclosure. In operation 502, the method 500 creates a hierarchical cluster of hierarchically organized connected clusters. In some embodiments, the hierarchically organized connected clusters form a tree data structure. In such an embodiment, the method 500 creates a root cluster of the hierarchical cluster and creates one or more descendant clusters that descend from the root cluster, thereby forming a number of cluster levels.

Hierarchical cluster metadata is embedded in each cluster to enable the clusters to identify and communicate with connected clusters (e.g., parent, child, and/or sibling clusters). In some embodiments, a hierarchical cluster metadata file can be used at the time of provisioning the clusters of the hierarchical cluster to automatically embed hierarchy information into each cluster. In some embodiments, the hierarchy of the hierarchical cluster can be setup manually by entering the hierarchy information in the pod configuration of a cluster at the time of provisioning. Also, in some embodiments, a hierarchical cluster metadata file can be generated for an existing hierarchical cluster by traversing the complete hierarchy and collecting hierarchy information from each cluster of the hierarchical cluster. In some embodiments, each respective cluster of the hierarchical cluster maintains hierarchical cluster metadata, which includes updating the hierarchical cluster metadata to reflect changes to the hierarchical cluster initiated at the respective cluster, and providing updates to the hierarchical cluster metadata to connected clusters (e.g., parent, child, and/or sibling clusters) to enable the connected clusters to update the hierarchical cluster metadata maintained at the connected clusters.

Each respective cluster of the hierarchical cluster is configured to perform operations for: receiving a command at a respective cluster of the hierarchical cluster; executing the command at the respective cluster; determining a scope of the command; and distributing the command to one or more clusters of the hierarchical cluster that are connected to the respective cluster and are determined to be included in the scope of the command. Accordingly, in operation 504, the method 500 receives a command at a respective cluster (also referred to herein as a “current cluster”) of the hierarchical cluster. The respective cluster can be the root cluster of the hierarchical cluster or any of the descendant clusters of the root cluster selected by a user to receive the command. For example, if the user wants the complete hierarchical cluster to perform the command, the user can select the root cluster to receive the command. If instead the user wants only a portion of the hierarchical cluster (e.g., a subtree) to perform the command, the user can select a target cluster (e.g., a top cluster of a subtree) to receive the command.

The command can include parameters that specify an action to be performed and one or more clusters that are to perform the action. The command can include, but is not limited to: a deploy command that deploys a cluster(s) to the hierarchical cluster; a get info command that obtains information for a cluster(s), worker node(s), and/or pod(s) of the hierarchical cluster; a create namespace command that creates a namespace in the hierarchical cluster; a scale command that scales up or scales down the hierarchical cluster; a restart command that restarts one or more clusters included in the hierarchical cluster; and other commands as will be appreciated by persons of ordinary skill.

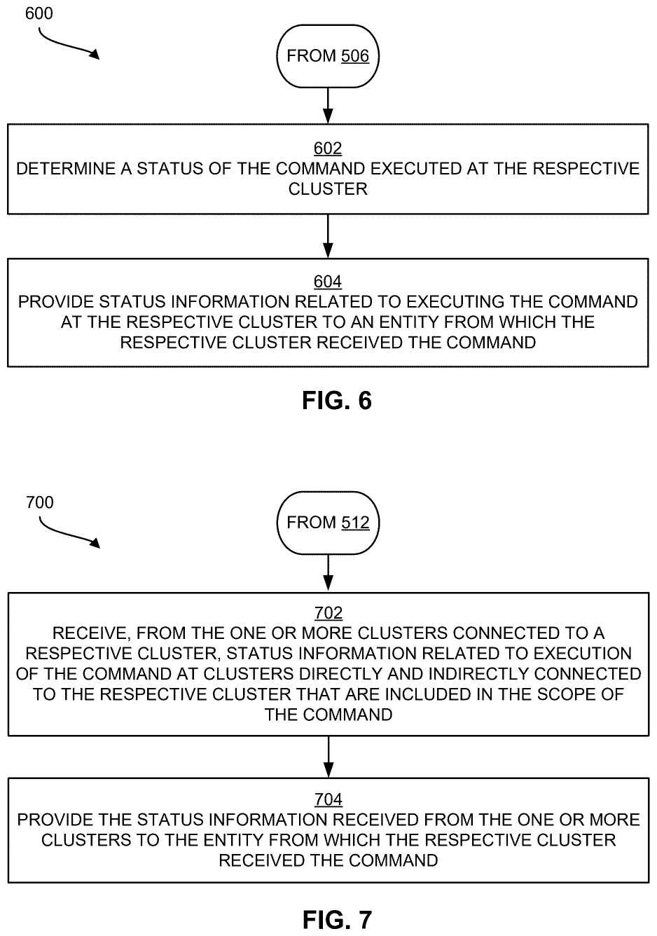

In operation 506, the method 500 executes the command at the respective cluster. Executing the command at the respective cluster can comprise sending an instruction to an appropriate component (e.g., a component 200 illustrated in FIG. 2 or a control plane component for the cluster) to perform the action specified by the command. Also, as described later in association with FIG. 6, in some embodiments the respective cluster provides a status of the command during and/or after execution of the command.

In operation 508, the method 500 determines a scope of the command. The scope of a command can be the complete hierarchical cluster or a portion of the hierarchical structure (e.g., a subtree of the hierarchical cluster or a percentage of clusters of the hierarchical cluster). The scope of the command can be determined by evaluating the parameters of the command to identify one or more clusters of the hierarchical cluster that are connected to the respective cluster and are included in the scope of the command.

In operation 510, the method 500 determines whether to distribute the command to connected clusters based on the scope of the command. In the case that the respective cluster's connected clusters are included in the scope of the command, the method 500, in operation 512, distributes the command to the one or more clusters of the hierarchical cluster that are connected to the respective cluster. A connected cluster that receives the command from the respective cluster executes the command. The connected cluster also evaluates the command to determine the scope of the command and, if the connected cluster is not a terminal cluster in the scope of the command, distributes the command to its connected cluster(s) that are included in the scope of the command. This process is continued until the command is distributed to each cluster that is included in the scope of the command. In the case that the respective cluster's connected clusters are not included in the scope of the command, or the respective cluster is a terminal cluster in the scope of the command, then the method 500 ends. In some embodiments, as described later in association with FIG. 7, connected clusters to which the command was distributed provide a status of the command to the entity (e.g., a parent cluster or user) from which the connected clusters received the command.

In an example where a sibling cluster(s) is included in the scope of the command, the current cluster requests a cluster identifier(s) for the sibling cluster(s) from the parent cluster of the current cluster. In response, the parent cluster obtains the cluster identifier(s) from the hierarchical cluster metadata maintained on the parent cluster. That is, the parent cluster obtains cluster identifier(s) for the parent cluster's children clusters, which are sibling cluster(s) of the current cluster. The parent cluster then returns the cluster identifier(s) for the sibling cluster(s) to the current cluster. After obtaining the cluster identifier(s) for the sibling cluster(s), the current cluster sends the command to the sibling cluster(s).

FIG. 6 is a flow diagram illustrating an example method 600 for providing a status of a command to an issuer of the command, in accordance with some embodiments of the present disclosure. As described in association with FIG. 5, in response to receiving a command, a respective cluster of a hierarchical cluster executes the command at the respective cluster. As part of executing the command at the respective cluster, the method 600 in operation 602 determines a status of the command, and in operation 604, the method 600 provides information related to executing the command to an entity from which the respective cluster received the command. For example, the method 600 can query a control plane of the respective cluster to obtain information related to execution of the command at the respective cluster, and the method 600 can send the information to the entity that issued the command to the respective cluster. In the case that the respective cluster is the root cluster of the hierarchical cluster, or the respective cluster is a top cluster of a subtree of the hierarchical cluster, then a user (e.g., an individual, a computer, or an application) is the entity that issued the command. In the case that the respective cluster is a child cluster, then the parent cluster of the respective cluster is the entity that issued the command.

FIG. 7 is a flow diagram illustrating an example method 700 for forwarding status information for a command up the hierarchy of a hierarchical cluster, in accordance with some embodiments of the present disclosure. As described in association with FIG. 5, a command can be executed by a hierarchical cluster (or a portion of the hierarchical cluster) by distributing the command to the clusters included in the scope of the command. As part of executing the command at each cluster that received the command, the clusters provide status information related to execution of the command to the entity from which the clusters received the command, such that the status information is forwarded up the hierarchy of the hierarchical cluster to provide the status information to a user that issued the command. Namely, after a respective cluster distributes a command to one or more connected clusters (e.g., child clusters), the method 700, in operation 702, receives status information related to execution of the command from the one or more clusters. The status information can be from both directly and indirectly connected clusters that are included in the scope of the command (as shown in FIG. 4). In operation 704, the method 700 provides the status information received from the directly and indirectly connected clusters to the entity from which the respective cluster received the command. Accordingly, the status information is sent up the hierarchy of the hierarchical cluster (e.g., from child cluster to parent cluster) until it reaches the initial cluster that first received the command, whereupon the initial cluster provides the status information to the user that issued the command.

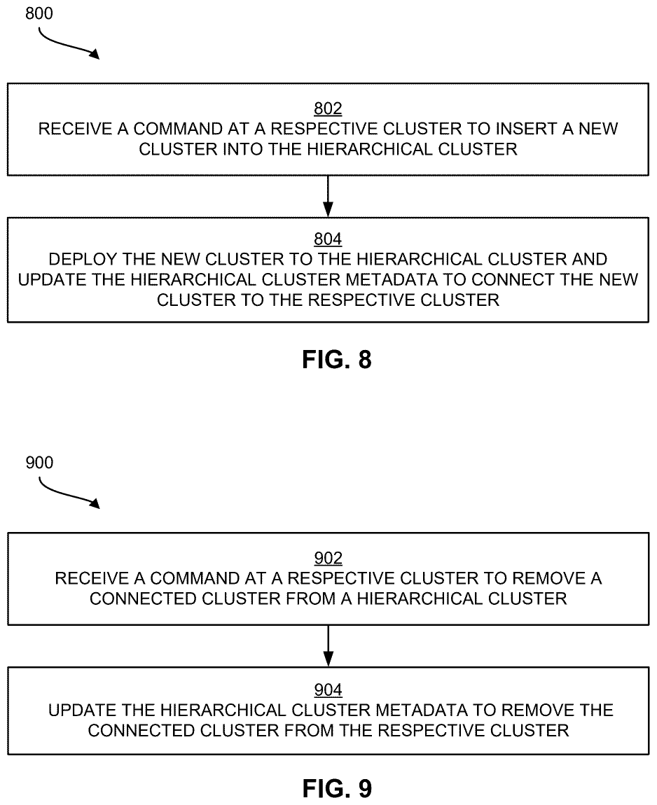

FIG. 8 is a flow diagram that illustrates an example method 800 for inserting a new cluster into a hierarchical cluster, in accordance with some embodiments of the present disclosure. In operation 802, the method 800 receives a command at a respective cluster to insert a new cluster into the hierarchical cluster. Illustratively, the command can be associated with the initial creation of the hierarchical cluster or scaling up the hierarchical cluster. In response to receiving the command, the method 800, in operation 804, deploys the new cluster to the hierarchical cluster and updates the hierarchical cluster metadata to connect the new cluster to the respective cluster. Updating the hierarchical cluster metadata includes updating hierarchical cluster metadata on the respective cluster with the new cluster's configuration and authentication information (e.g., the new cluster's Kubeconfig file), and updating hierarchical cluster metadata on the new cluster with the respective cluster's configuration and authentication information (e.g., respective cluster's Kubeconfig file).

FIG. 9 is a flow diagram illustrating an example method 900 for removing a connected cluster from a hierarchical cluster, in accordance with some embodiments of the present disclosure. In operation 902, the method 900 receives a command at a respective cluster to remove a connected cluster from a hierarchical cluster. Illustratively, the command can be associated with scaling down the hierarchical cluster. In response to receiving the command, the method 900, in operation 904 updates the hierarchical cluster metadata to remove the connected cluster from the respective cluster, which effectively removes the connected cluster from the hierarchical cluster. Also, in some embodiments, the method 900 deletes the computing resources that implement the connected cluster. Alternatively, in some embodiments, the computing resources are preserved to allow the cluster to be repurposed (e.g., assigned to another hierarchical cluster).

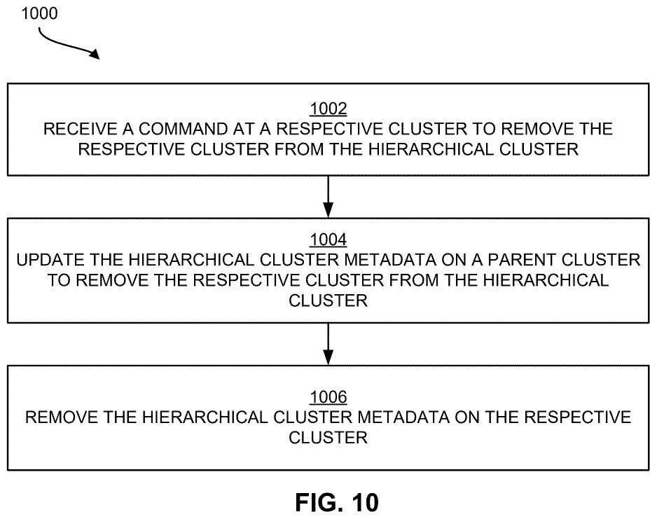

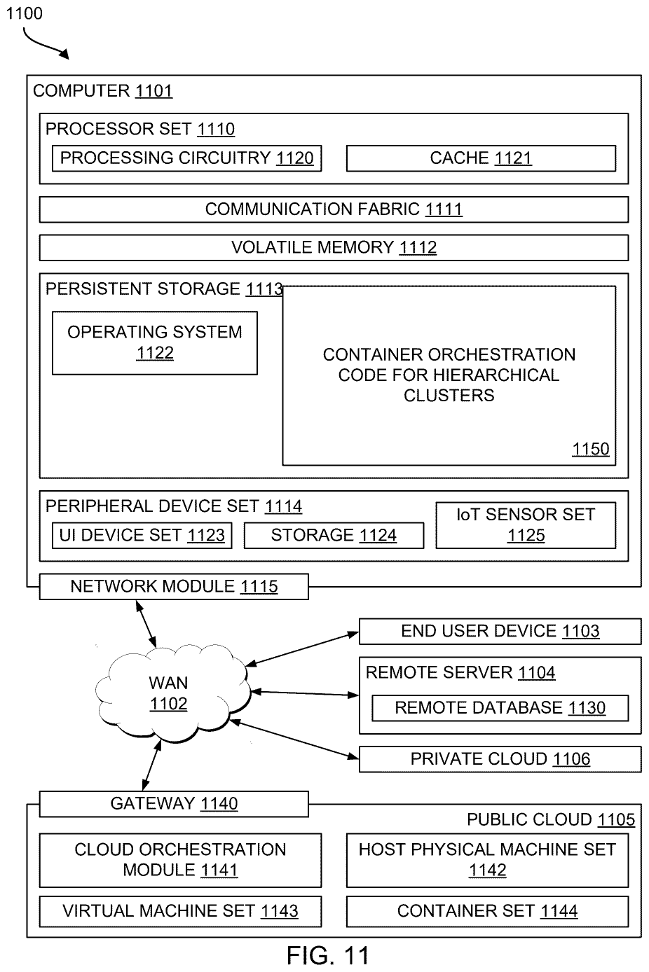

FIG. 10 is a flow diagram that illustrates an example method 1000 for removing a respective cluster from a hierarchical cluster, in accordance with some embodiments of the present disclosure. In operation 1002, the method 1000 receives a command at a respective cluster of a hierarchical cluster to remove itself from the hierarchical cluster. In response, the method 1000, in operation 1004 sends a request to the parent cluster of the respective cluster to update its hierarchical cluster metadata to remove the respective cluster, which effectively removes the respective cluster from the hierarchical cluster. Also, in operation 1006, the method 1000 removes (deletes) the hierarchical cluster metadata located on the respective cluster, thereby preventing the respective cluster from communicating with the hierarchical cluster. Also, in some embodiments, the method 1000 deletes the computing resources that implement the respective cluster. Alternatively, in some embodiments, the computing resources are preserved to allow the cluster to be repurposed (e.g., assigned to another hierarchical cluster).

The methods described above can be performed by a computer (e.g., computer 1101 in FIG. 11), performed in a cloud environment (e.g., clouds 1106 or 1105 in FIG. 11), and/or generally can be implemented in fixed-functionality hardware, configurable logic, logic instructions, etc., or any combination thereof.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media or medium, as the terms are used in the present disclosure, are not to be construed as storage in the form of transitory signals per se. Namely, a computer-readable storage media or medium is not radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 1100 contains an example of an environment for the execution of at least some of the computer code involved in performing the disclosed methods, such as container orchestration code for hierarchical clusters 1150. In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1150, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer-readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as cache 1121 and the other storage media discussed below. The computer-readable program instructions, and associated data, are accessed by processor set 1110 to control and direct performance of the disclosed methods. In computing environment 1100, at least some of the instructions for performing the disclosed methods may be stored in block 1150 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1150 typically includes at least some of the computer code involved in performing the disclosed methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer-readable program instructions for performing the disclosed methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

It will be further appreciated that various aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A computer-implemented method comprising:
creating a hierarchical cluster of hierarchically organized connected clusters, where a respective cluster of the hierarchical cluster comprises a group of worker nodes that host pods of one or more containers, where at least one of the pods is configured to perform operations that include:
receiving a command at the respective cluster of the hierarchical cluster, where the command is for execution by at least a portion of the hierarchical cluster;
executing the command at the respective cluster of the hierarchical cluster;
determining a scope of the command, where the command is evaluated to identify one or more clusters of the hierarchical cluster that are connected to the respective cluster and are included in the scope of the command; and
distributing the command to the one or more clusters of the hierarchical cluster that are connected to the respective cluster and are included in the scope of the command.

2. The computer-implemented method of claim 1, wherein creating the hierarchical cluster further comprises:
creating a root cluster of the hierarchical cluster to include the one or more pods configured to perform the operations that include the receiving, executing, and distributing of the commands; and
creating one or more descendant clusters that descend from the root cluster, the one or more descendant clusters including the one or more pods configured to perform the operations that include the receiving, executing, and distributing of the commands.

3. The computer-implemented method of claim 1, wherein creating the hierarchical cluster further comprises:
generating hierarchical cluster metadata to indicate a hierarchy of the connected clusters; and
storing the hierarchical cluster metadata on each cluster of the hierarchical cluster to enable each cluster of the hierarchical cluster to identify the connected clusters.

4. The computer-implemented method of claim 1, wherein the one or more pods are further configured to perform operations that include:
providing information related to executing the command at the respective cluster to an entity from which the respective cluster received the command;
receiving, from the one or more clusters connected to the respective cluster, additional information related to execution of the command at clusters directly and indirectly connected to the respective cluster that are within the scope of the command; and
providing the additional information to the entity from which the respective cluster received the command.

5. The computer-implemented method of claim 1, wherein the one or more pods are further configured to perform operations that include:
maintaining hierarchical cluster metadata for the hierarchical cluster at the respective cluster, including updating the hierarchical cluster metadata to reflect changes to the hierarchical cluster initiated at the respective cluster; and
providing updates to the hierarchical cluster metadata to the one or more clusters of the hierarchical cluster that are connected to the respective cluster to enable the one or more clusters to update the hierarchical cluster metadata maintained at the one or more clusters.

6. The computer-implemented method of claim 1, wherein the one or more pods are further configured to perform operations that include:
inserting a new cluster into the hierarchical cluster, where hierarchical cluster metadata for the hierarchical cluster is updated to connect the new cluster to the respective cluster; and
removing a connected cluster from the hierarchical cluster, where the connected cluster is connected to the respective cluster and the hierarchical cluster is updated to remove the connected cluster from the respective cluster.

7. The computer-implemented method of claim 1, wherein the one or more pods are further configured to perform operations that include:
removing the respective cluster from the hierarchical cluster in response to a command that instructs the respective cluster to remove itself form the hierarchical cluster.

8. The computer-implemented method of claim 1, wherein determining the scope of the command further comprises:
evaluating the command to determine a subtree of clusters of the hierarchical cluster that is to execute the command.

9. The computer-implemented method of claim 1, wherein determining the scope of the command further comprises:
evaluating the command to determine a percentage of clusters of the hierarchical cluster that are to execute the command.

10. A computer system comprising:
a processor set;
one or more computer-readable storage media; and
program instructions stored on the one or more computer-readable storage media to cause the processor set to perform operations comprising:
creating a hierarchical cluster of hierarchically organized connected clusters, where a respective cluster of the hierarchical cluster comprises a group of worker nodes that host pods of one or more containers, where at least one of the pods is configured to perform operations that include:
receiving a command at the respective cluster of the hierarchical cluster, where the command is for execution by at least a portion of the hierarchical cluster;
executing the command at the respective cluster of the hierarchical cluster;
determining a scope of the command, where the command is evaluated to identify one or more clusters of the hierarchical cluster that are connected to the respective cluster and are included in the scope of the command; and
distributing the command to the one or more clusters of the hierarchical cluster that are connected to the respective cluster and are included in the scope of the command.

11. The computer system of claim 10, wherein the program instructions for creating the hierarchical cluster further cause the processor set to perform operations comprising:
generating hierarchical cluster metadata to indicate a hierarchy of the connected clusters; and
storing the hierarchical cluster metadata on each cluster of the hierarchical cluster to enable each cluster of the hierarchical cluster to identify the connected clusters.

12. The computer system of claim 10, wherein the one or more pods are further configured to perform operations that include:
providing information related to executing the command at the respective cluster to an entity from which the respective cluster received the command;
receiving, from the one or more clusters connected to the respective cluster, additional information related to execution of the command at clusters directly and indirectly connected to the respective cluster that are within the scope of the command; and
providing the additional information to the entity from which the respective cluster received the command.

13. The computer system of claim 10, wherein the one or more pods are further configured to perform operations that include:
maintaining hierarchical cluster metadata for the hierarchical cluster at the respective cluster, including updating the hierarchical cluster metadata to reflect changes to the hierarchical cluster initiated at the respective cluster; and
providing updates to the hierarchical cluster metadata to the one or more clusters of the hierarchical cluster that are connected to the respective cluster to enable the one or more clusters to update the hierarchical cluster metadata maintained at the one or more clusters.

14. The computer system of claim 10, wherein the one or more pods are further configured to perform operations that include:
inserting a new cluster into the hierarchical cluster, where hierarchical cluster metadata for the hierarchical cluster is updated to connect the new cluster to the respective cluster; and
removing a connected cluster from the hierarchical cluster, where the connected cluster is connected to the respective cluster and the hierarchical cluster is updated to remove the connected cluster from the respective cluster.

15. The computer system of claim 10, wherein determining the scope of the command further comprises:
evaluating the command to determine a subtree of clusters of the hierarchical cluster that is to execute the command; or
evaluating the command to determine a percentage of clusters of the hierarchical cluster that are to execute the command.

16. A computer program product comprising:
one or more computer-readable storage media; and
program instructions stored on the one or more computer-readable storage media to cause a processor set to perform operations comprising:
creating a hierarchical cluster of hierarchically organized connected clusters, where a respective cluster of the hierarchical cluster comprises a group of worker nodes that host pods of one or more containers, where at least one of the pods is configured to perform operations that include:
receiving a command at the respective cluster of the hierarchical cluster, where the command is for execution by at least a portion of the hierarchical cluster;
executing the command at the respective cluster of the hierarchical cluster;
determining a scope of the command, where the command is evaluated to identify one or more clusters of the hierarchical cluster that are connected to the respective cluster and are included in the scope of the command; and
distributing the command to the one or more clusters of the hierarchical cluster that are connected to the respective cluster and are included in the scope of the command.

17. The computer program product of claim 16, wherein the program instructions for creating the hierarchical cluster further cause the processor set to perform operations comprising:
generating hierarchical cluster metadata to indicate a hierarchy of the connected clusters that enables each cluster of the hierarchical cluster to identify the connected clusters,
wherein the hierarchical cluster metadata for the hierarchical cluster is maintained at the respective cluster, including operations for updating the hierarchical cluster metadata to reflect changes to the hierarchical cluster initiated at the respective cluster.

18. The computer program product of claim 16, wherein the one or more pods are further configured to perform operations that include:
providing information related to executing the command at the respective cluster to an entity from which the respective cluster received the command;
receiving, from the one or more clusters connected to the respective cluster, additional information related to execution of the command at clusters directly and indirectly connected to the respective cluster that are within the scope of the command; and
providing the additional information to the entity from which the respective cluster received the command.

19. The computer program product of claim 16, wherein the one or more pods are further configured to perform operations that include:
inserting a new cluster into the hierarchical cluster, where hierarchical cluster metadata for the hierarchical cluster is updated to connect the new cluster to the respective cluster; and
removing a connected cluster from the hierarchical cluster, where the connected cluster is connected to the respective cluster and the hierarchical cluster is updated to remove the connected cluster from the respective cluster.

20. The computer program product of claim 16, wherein determining the scope of the command further comprises:
evaluating the command to determine a subtree of clusters of the hierarchical cluster that is to execute the command; or
evaluating the command to determine a percentage of clusters of the hierarchical cluster that are to execute the command.
